(19) United States
(12) Patent Application Publication
(10) Pub. No.: US 2026/0027622 A1
(43) Pub. Date: Jan. 29, 2026

(54) HYBRID WIRE AND SLAG-BASED ADDITIVE MANUFACTURING

(71) Applicant: UT-Battelle, LLC, Oak Ridge, TN (US)

(72) Inventors: Brian K. Post, Knoxville, TN (US); Adam Stevens, Lenoir City, TN (US); James Robert Tobin, Greenville, SC (US); Sudarsanam Suresh Babu, Knoxville, TN (US); Vanshika Singh, Oak Ridge, TN (US); David Hebble, Houston, TX (US); Peeyush Nandwana, Oak Ridge, TN (US); Rangasayee Kannan, Oak Ridge, TN (US); Paritosh Mhatre, Oak Ridge, TN (US)

(21) Appl. No.: 19/278,108

(22) Filed: Jul. 23, 2025

Related U.S. Application Data
(60) Provisional application No. 63/674,370, filed on Jul. 23, 2024.

(51) Int. Cl. B22F 10/22; B22F 10/68; B22F 10/85; B23K 9/04; B23K 25/00; B33Y 10/00; B33Y 40/00; B33Y 50/02

(52) U.S. Cl. CPC B22F 10/22; B22F 10/68; B22F 10/85; B23K 9/044; B23K 25/005; B33Y 10/00; B33Y 40/00; B33Y 50/02

(57) ABSTRACT

A hybrid electroslag additive manufacturing method is provided. This hybrid method combines the benefits of wire-arc additive manufacturing with the benefits of electroslag welding and casting. As discussed herein, the hybrid method employs an interleaved wall-and-infill strategy, wherein the wall is manufacturing via wire-arc additive manufacturing or other directed energy deposition, and the infill is provided by electroslag welding/casting techniques or similar processes, such as submerged arc welding. The hybrid method can produce large, complex components at higher rates with lower lead times than either of the techniques individually.

### CROSS-REFERENCE TO RELATED APPLICATIONS

This application claims the benefit of U.S. Provisional Application 63/674,370, filed Jul. 23, 2024, the disclosure of which is incorporated by reference in its entirety.

### STATEMENT REGARDING FEDERALLY SPONSORED RESEARCH AND DEVELOPMENT

This invention was made with government support under Contract No. DE-AC05-00OR22725 awarded by the U.S. Department of Energy. The government has certain rights in the invention.

### BACKGROUND OF THE INVENTION

A growing number of methods exist for the manufacture of metallic components. As one example, wire-arc additive manufacturing is a known method which commonly uses a single welding torch that is controlled by a robotic manipulator to deposit less than 10 lbs/hr of metal. In addition, bead-to-bead porosity and defects are common, and property sets are highly dependent upon the toolpath and geometry of the component being manufactured. In comparison, casting processes produce more uniform material properties, result in less deformation (due to more equalized thermal processing conditions) and less cracking due to low temperature differentials across the part at higher deposition rates. Unfortunately, however, casting processes require molds which are complex and expensive and which preclude complex and spatially dependent material chemistry augmentations. These shortcomings underscore the continued need for an improved manufacturing approach that combines the geometric flexibility and speed of additive manufacturing techniques with the material integrity and scale of casting, ultimately enabling the production of large, high-performance components with greater efficiency and reliability.

### SUMMARY OF THE INVENTION

A hybrid electroslag additive manufacturing method is provided. This hybrid method combines the benefits of wire-arc additive manufacturing with the benefits of electroslag casting or welding. As discussed herein, the hybrid method employs an interleaved wall-and-infill strategy, wherein the wall is manufactured via wide-arc additive manufacturing or other directed energy deposition process, and the infill is provided by electroslag casting/welding or similar processes, such as submerged arc welding. The hybrid method can produce large, complex components at higher rates with lower lead times than either of the techniques individually.

In one embodiment, the hybrid method integrates wire-arc additive manufacturing with electroslag welding or electroslag casting in an iterative and interleaved sequence. In this approach, wire-arc additive manufacturing is used to fabricate consumable mold walls with internal features tailored to the desired part geometry. Once a segment of the mold cavity is deposited on the build plate, it is immediately filled within molten metal using an electroslag process. The electroslag process melts a feedstock electrode within a conductive slag pool, directing the molten metal into the newly formed mold cavity.

As the process iterates, alternating between wire-arc additive manufacturing mold formation and electroslag infill, a near-net component is progressively built, layer by layer. The mold walls serve to contain the molten slag and melt pool, and the mold walls can be integral to the final component or removed later, for example machined off or chemically removed. The hybrid method can also include an interpass cleaning step between successive deposition cycles, in which surface contaminants or oxides are removed using laser ablation or mechanical grinding. The result is a scalable, material-efficient, and cost-effective method for producing complex structural parts with enhanced mechanical and metallurgical performance.

These and other features and advantages of the present invention will become apparent from the following description of the invention, when viewed in accordance with the accompanying drawings and appended claims.

### BRIEF DESCRIPTION OF THE DRAWINGS

FIG. 1 is a schematic view of a hybrid manufacturing method in accordance with a first embodiment.

FIG. 2 is a schematic view of a hybrid manufacturing method in accordance with a second embodiment.

FIG. 3 illustrates a laboratory sample formed in accordance with the hybrid manufacturing method of FIG. 1.

### DETAILED DESCRIPTION OF THE CURRENT EMBODIMENTS

The current embodiments include a hybrid manufacturing method that integrates wire-arc additive manufacturing with a flux-based welding process in an iterative and interleaved sequence. The method first includes forming at least one layer of a mold wall via wire-arc additive manufacturing. As used herein, a “wall” is any structure that partially or completely impedes lateral movement of molten material, such as continuous structures, castellated structures, or other discontinuous structures. To perform this operation, a robotic arm or gantry system including a welding torch is positioned over a build plate. As used herein, a “build plate” (or “build platform” or “base plate”) is any metallic component upon which walls can be attached, and it need not be a flat surface. A spool of metal wire is mounted and fed to the torch, the metal wire including but not limited to any suitable metal such as carbon steel, low alloy steel, stainless steel (such as 300/400 series), nickel alloys, titanium, or aluminum. An electric arc is struck between the electrode/wire electrode and the build plate (or the previously deposited layer of the build/mold wall), which melts the tip of the wire and a portion of the underlying material. The torch moves along according to a preprogrammed toolpath, and cooling occurs after deposition, solidifying the mold wall, which causes the internal geometry of the mold (the mold cavity) to take shape. The present invention is not limited to wire-arc additive manufacturing. Other directed energy deposition techniques can also be used to form the mold walls, including for example laser-based deposition, electron-beam additive manufacturing, and plasma arc additive manufacturing. Still other techniques can be used in other embodiments.

After a partial wall has been additively formed with a suitable height, the hybrid method includes casting molten metal into the shallow mold cavity. This step includes melting a metal electrode and a molten slag via a flux-based welding process, such that the molten metal flows into and takes the form of the shallow mold cavity. In one embodiment, electroslag casting is used. Electroslag casting includes melting a consumable metal electrode through a superheated, electrically conductive molten slag bath. As the molten metal accumulates in the partial mold, it solidifies, resulting in a thin casting layer with low porosity, refined grain structure, and reduced impurities. Relative motion between the deposition head and the shallow mold cavity may be used to ensure appropriate coverage of the cavity with molten slag and metal material. Other flux-based welding infill methods can be used in other embodiments, including electroslag welding, electroslag strip cladding, submerged arc welding, or flux-core arc welding for example, in which a consumable electrode is melted to form a slag bath. Other embodiments may utilize electro-magnetic or magnetic-field assisted steering devices to guide the deposition of the molten slag and material.

Once the combination of slag and metal solidifies, the hybrid method alternates between the foregoing steps to construct the finished component layer-by-layer. Over time, the combined action of wall formation and molten material infill results in the progressive creation of a three-dimensional structure, in which the walls may be partially consumed, melted, or displaced during the manufacturing process. Each iteration includes the formation of at least one layer of a mold wall to form a shallow mold cavity, each layer of the mold wall having a height of less than 30 mm, optionally less than 100 mm, further optionally less than 1000 mm, still further optionally greater than 1000 mm, followed by another flux-based welding deposition cycle, again melting and at least partially filling the new cavity. This process is repeated in an interleaved, additive manner, layer by layer, until the entire three-dimensional component is built. The wall and infill material can be the same material or different materials, and the identity of material can vary throughout a printed body, based on the needs of the application. Interpass and post-build cleaning to remove contaminants such as oxides and slag can be performed using laser ablation, grinding, needle-gun, or vacuuming, by non-limiting example.

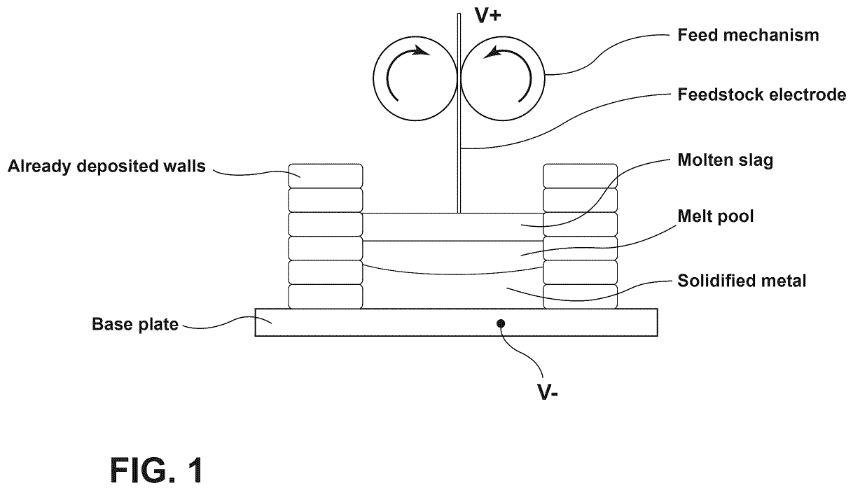

FIG. 1 is illustrative of one embodiment of the hybrid method. In this embodiment, the outer mold walls are constructed by depositing material onto a build plate using a feed mechanism and an energy source, for example an electric arc or a laser. The additively formed walls extend vertically to form a shallow mold cavity with a desired shape and height. Once the walls are sufficiently high, molten material consisting of metal and slag is introduced into the shallow mold cavity via a flux-based welding technique. The molten material can be initially introduced by melting in a separate apparatus and pouring into the cavity, after which a flux-based welding technique is used to continue the filling of the shallow mold cavity, or the molten material can be generated in the shallow mold cavity by the action of a flux-based welding technique, after which the continued filling of the cavity is performed with a flux-based welding technique. In one example, the build plate is electrically grounded, and the metal electrode is held at a positive voltage potential and melted by an electric arc or via resistive heating within the molten slag. In other examples the electrode may be grounded and the build plate held at a positive potential, or an alternating potential may be used between electrode and build plate, or there may be a plurality of electrodes and the voltage potential is established between the electrodes. The process continues iteratively, with slag added and solidified in layers until the shallow mold cavity is filled to the desired level. Post-processing (e.g., machining or heat treatment) can be used to refine the surfaces or to enhance material properties of the manufactured component.

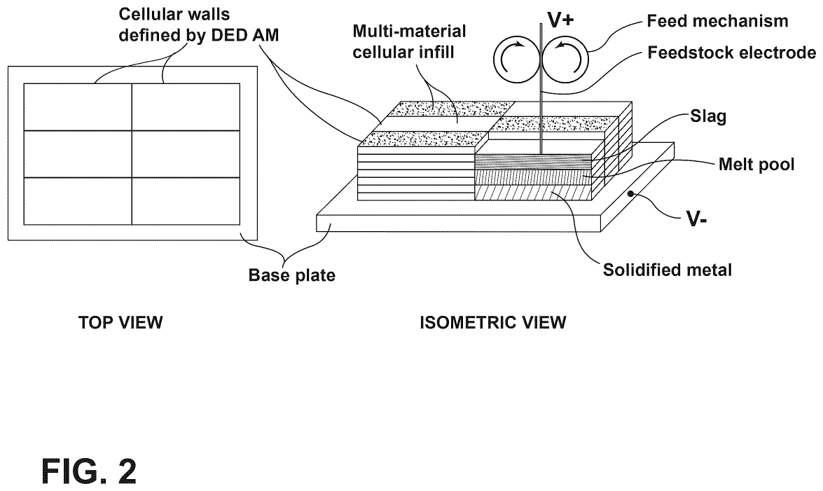

FIG. 2 is illustrative of another embodiment of the hybrid method. In this embodiment, cellular walls are formed on a build plate by directed energy deposition. In this embodiment, six rectangular mold cavities are formed, creating a grid-like cellular design. The interior of these cells is filled with a multi-material infill, which includes molten slag and solidified metal, deposited layer-by-layer. This process occurs on a build plate, and FIG. 2 provides each of a top view and an isometric view to highlight the cellular architecture. The use of multiple materials achieves a composite structure, including a first casting in a first plurality of cells, and a second casting in a second plurality of cells, the first casting comprising a different metal or metal alloy than the second casting. The foregoing process remains rooted in directed energy deposition of the mold walls, as in the embodiment of FIG. 1, but expands the infill strategy to include two or more metals, making the present invention suitable for advanced manufacturing methods and use cases.

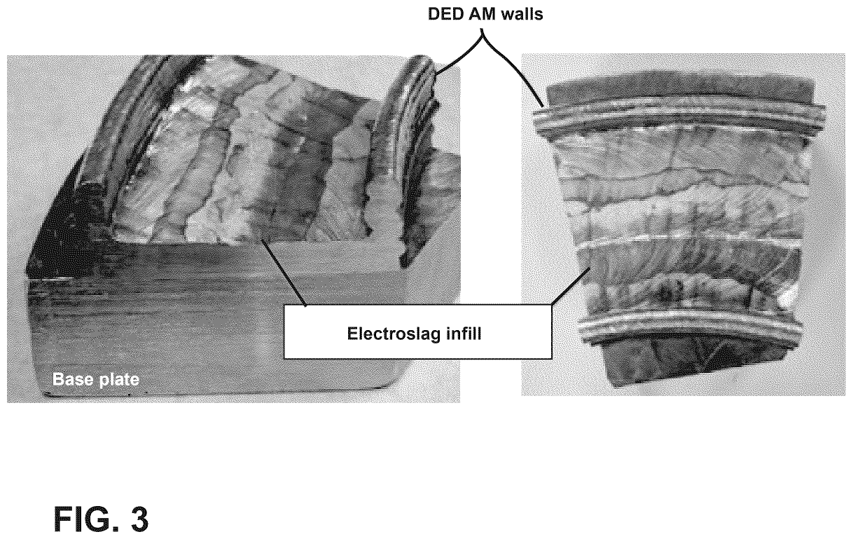

In one laboratory example, illustrated in FIG. 3, the hybrid method was demonstrated within an annular build with a total radial thickness of approximately 60 mm. This example combined gas tungsten arc welding retaining walls with electroslag strip cladding infill. Walls were formed via gas tungsten arc welding with small-diameter wire (e.g., 0.045″). Infill was performed using a split bead technique, wherein two parallel 30 mm beads were deposited by relative motion between electroslag strip cladding unit and the build, to produce the total wall thickness of 60 mm. The deposition rate was only limited by power supply, feedstock form factor (standard sizes being available at 15, 30, 60, 90, and 120 mm widths and 0.5 mm thickness), and thermal considerations.

To reiterate, the present invention provides a hybrid manufacturing process that integrates wire-arc additive manufacturing with a flux-based welding technique in an interleaved sequence, which provides a means for defining and containing the large molten slag and melt pools associated with the flux-based welding technique. As the process iterates, alternating between wire-arc additive manufacturing mold formation and flux-based welding infill, a near-net component is progressively built, layer by layer. The mold walls serve to contain the metal melt pool, molten slag, and unmelted flux, and the mold walls can be integral to the final component or removed later. The hybrid method can also include an interpass cleaning step between successive deposition cycles, in which surface contaminants or oxides are removed using laser ablation, abrasive blasting, mechanical griding, or a needlegun scaler, by not limiting example. The result is a scalable, material-efficient, and cost-effective method for producing complex structural parts with enhanced mechanical and metallurgical performance.

The above description is that of current embodiments of the invention. Various alterations and changes can be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular.

1. A hybrid manufacturing method comprising:
automatically attaching a plurality of walls on a build plate to define one or more mold cavities;
filling one or more mold cavities with a molten infill by a flux-based welding process, wherein an electrode and flux is melted and the combined material is deposited into the one or more mold cavities;
allowing the molten infill to solidify within the one or more mold cavities to form a portion of a metallic component; and
automatically attaching subsequent layers of the plurality of walls and depositing additional layers of the molten infill within the one or more mold cavities;
wherein the plurality of walls are unaffected, partially consumed, displaced, remelted, or entirely consumed due to the filling of the mold cavity with the molten infill.

2. The hybrid manufacturing method of claim 1, wherein the walls are additively formed using a directed energy deposition process.

3. The hybrid manufacturing method of claim 1, wherein a portion of the plurality of walls are retained as an integral part of the metallic component.

4. The hybrid manufacturing method of claim 2, wherein the directed energy deposition process includes wire-arc additive manufacturing.

5. The hybrid manufacturing method of claim 4, wherein the wire-arc additive manufacturing process includes gas tungsten arc welding or gas metal arc welding.

6. The hybrid manufacturing method of claim 1, wherein the flux-based welding process comprises an electroslag process and the electroslag process used is one or more of electroslag casting, electroslag welding, electroslag strip cladding, or a similar process such as submerged arc welding, submerged arc strip cladding, or flux-core arc welding.

7. The hybrid manufacturing method of claim 1, wherein the flux-based welding process is guided by a computer numerical control system or a robotic arm.

8. The hybrid manufacturing method of claim 2, wherein the directed energy deposition process is guided by a computer numerical control system or a robotic arm.

9. The hybrid manufacturing method of claim 2, wherein the directed energy deposition process uses metal-core, flux-core, or solid wire.

10. The hybrid manufacturing method of claim 2, wherein subsequent operations of the directed energy deposition process and the molten infill process are performed in an iterative and interleaved manner to build successive layers of the metallic component.

11. The hybrid manufacturing method of claim 1, wherein the mold cavity is a first mold cavity, the method including forming a second mold cavity adjacent to the first mold cavity via the directed energy deposition process.

12. The hybrid manufacturing method of claim 10, wherein the molten infill includes a first metal slag, the method including introducing a second metal slag into second mold cavity, the second molten slag being different from the first molten slag.

13. The hybrid manufacturing method of claim 1, further including an interpass cleaning step between successive deposition cycles, wherein flux, slag, surface contaminants, or oxides are removed.

14. The hybrid manufacturing method of claim 13, wherein the interpass cleaning is performed with laser ablation, mechanical grinding, needlegun scaler, or abrasive blasting.

15. A method of manufacturing a metallic component, comprising:
forming a layer of a mold wall via a directed energy deposition process, wherein a metal wire feedstock is melted by an electric arc and deposited in a programmed geometry to form a mold cavity;
filling the mold cavity with molten metal generated by a flux-based welding process, wherein a filler metal and flux is melted to form a bath of molten material consisting of metal and slag, and directed into the mold cavity;
allowing the molten metal and slag to solidify within the mold cavity to form a portion of the metallic component; and
repeating the steps of forming a layer of the mold wall via the directed energy deposition process and filling the mold cavity via the flux-based welding process in an iterative, interleaved manner to build successive layers of the metallic component, wherein the mold walls are at least partially consumed or displaced due to the filling of the mold cavity with the molten metal.

16. The method of claim 15, wherein the directed energy deposition process includes gas tungsten arc welding or gas metal arc welding.

17. The method of claim 15, further including an interpass cleaning step between successive deposition cycles, wherein surface contaminants or oxides are removed using methods such as laser ablation or mechanical grinding.

18. The method of claim 15, wherein the directed energy deposition process is guided by a computer numerical control system or a robotic arm.

19. The method of claim 15, wherein the flux-based welding process is guided by a computer numerical control system or a robotic arm.

20. The method of claim 15, wherein each layer of the mold wall is not more than 30 mm in height.

21. A hybrid manufacturing method comprising:
additively forming a plurality of walls on a build plate using a directed energy deposition process to define plurality of mold cavities;
filling the first and second mold cavities with a multi-material infill by introducing a first molten material into the first mold cavity and introducing a second molten material into the second mold cavity, the first molten material comprising a metal and slag that is different from the second molten material;
allowing the first molten material and the second molten material to solidify within the first and second mold cavities, respectively; and
additively forming subsequent layers of the plurality of walls via the directed energy deposition process and depositing additional layers of the first molten material and the second molten material within the first and second mold cavities in an iterative manner to build successive layers of a metallic component, wherein the plurality of walls are at least partially consumed or displaced due to the filling of the plurality of the first and second mold cavities with molten slag.

22. The hybrid manufacturing method of claim 21, wherein the directed energy deposition process includes wire-arc additive manufacturing.

23. The hybrid manufacturing method of claim 22, wherein the wire-arc additive manufacturing process includes gas tungsten arc welding or gas metal arc welding.

24. The hybrid manufacturing method of claim 21, further including generating the first molten material and the second molten material via a flux-based welding process such as electroslag casting, electroslag welding, electroslag strip cladding, submerged arc welding, submerged arc strip cladding, or flux-core arc welding.

25. The hybrid manufacturing method of claim 21, wherein at least a portion of the plurality of walls are retained as an integral part of the metallic component.

26. The hybrid manufacturing method of claim 21, wherein the directed energy deposition process is guided by a computer numerical control system or robotic arm.

27. The hybrid manufacturing method of claim 21, wherein the infill process is guided by a computer numerical control system or a robotic arm.

28. The hybrid manufacturing method of claim 21, further including an interpass cleaning step between successive deposition cycles, wherein surface contaminants or oxides are removed using methods such as laser ablation or mechanical grinding.
